(19) United States
(12) Patent Application Publication
(10) Pub. No.: US 2010/0201568 A1
(43) Pub. Date: Aug. 12, 2010

(54) METHOD FOR IMPLEMENTING GPS SURVEYING FIELD WORK PLANNING USING 3D TOPOGRAPHIC INFORMAITON AND METHOD FOR ANALYZING 3D TOPOGRAPHIC INFORMATION

(75) Inventors: Jen-Yu Han, TAIPEI CITY (TW); Po-Han Lee, TAIPEI CITY (TW)

Correspondence Address: QUINTERO LAW OFFICE, PC, 615 Hampton Dr, Suite A202, Venice, CA, 90291, US

(73) Assignee: NATIONAL TAIWAN UNIVERSITY, TAIPEI (TW)

(21) Appl. No.: 12/552,859

(22) Filed: Sep. 2, 2009

(30) Foreign Application Priority Data
Feb. 9, 2009 (TW) TW098104017

(51) Int. Cl. G01S 1/00

(52) U.S. Cl. 342/357.06

(57) ABSTRACT

A method for implementing GPS surveying field work planning by using three dimensional topographic information is provided, comprising the steps of: obtaining three dimensional topographic information according to the location of a GPS receiver; obtaining maximum topographic elevation angle information from the GPS receiver to the terrain for each azimuth using the three dimension topographic information; obtaining elevation angle of satellites from the GPS receiver according to the satellite ephemeris or almanac; determining whether observation is usable according to the maximum topographic elevation angle information along the satellite bearings, and the elevation angle of satellites; and estimating the positioning accuracy according to the usable satellite observations.

### CROSS REFERENCE TO RELATED APPLICATION

This Application claims priority of Taiwan Patent Application No. 98104017, filed on Feb. 9, 2009, the entirety of which is incorporated by reference herein.

### BACKGROUND OF THE INVENTION

1. Field of the Invention

The present invention relates to a method for implementing GPS surveying field work planning, and in particular relates to a method for implementing GPS surveying field work planning using 3D topographic information.

2. Description of the Related Art

Typically, software such as Trimble Planning is used for implementing GPS surveying field work planning. The software is used to make preliminary estimation on surveying timing, planning location and measurement quality before a real field survey. The software can generate visible satellite number and positioning accuracy graphs, etc. for analysis and simulations. Satellite visibility analysis used for predicting visible observations and estimating positioning accuracy is one of the most critical features of the software.

Visibility is determined according to how a range of terrain obstructs satellite signals. In general, a simplified method is used by software for predicting obstacles without taking the real local terrain into consideration. For example, a mask angle is set at the lowest safe value to prevent a satellite's elevation angle from approaching horizontal, or a contour of obstacles is determined following manual circling of areas on a map to define ranges of obstructions such as mountain ridges or buildings around the location of users. Presently, this contour should be depicted by visually observing a real field terrain. Thus, the terrain contour is not precise and may be unsatisfactory when the required field information is not enough. Consequently, estimating terrain obstruction effect on satellite signals and GPS positioning accuracy may be unsatisfactory.

Thus, a method for implementing GPS surveying field work planning using 3D topographic information having the ability to precisely estimate positioning accuracy by employing three dimensional topography information to analyze terrain obstruction effect is required.

### BRIEF SUMMARY OF INVENTION

A detailed description is given in the following embodiments with reference to the accompanying drawings.

In one embodiment, the present invention provides a method for implementing GPS surveying field work planning using 3D topographic information. The method includes steps of: obtaining three dimensional topographic information according to the location of a GPS receiver; obtaining maximum the topographic elevation angle from the GPS receiver in each azimuths according to the three dimension topographic information; determining the elevation angles of satellites from the GPS receiver according to the satellite ephemeris or almanacs; determining whether observation information is visible according to the maximum topographic elevation angle information, and the elevation angle of a satellite along the same azimuth; and estimating a GPS receiver positioning accuracy according to the predicted visible satellite observations. Thus, an improved visible analysis of 3D topographic information is obtained and the satellite positioning accuracy is precisely predicted. As a result, the field work planning efficiency is improved.

In another embodiment, the present invention provides a method for analyzing 3D topographic information. The method includes steps of: obtaining topographic information; determining a location and a analysis area; obtaining topographic heights in the area with adaptive grid sizes according to the topographic variations, wherein the grid sizes are proportional to the distance between the receiver's location and the sampling points in the best-contemplated case; and obtaining maximum topographic elevation angle information according to the topographic heights and the height of the receiver's location. Note that self-adaptive non-equivalent interval sampling is used to speed up the analysis of 3D information of a large size to obtain topographic information approximating to the real field terrain.

### BRIEF DESCRIPTION OF DRAWINGS

The present invention can be more fully understood by reading the subsequent detailed description and examples with references made to the accompanying drawings, wherein:

FIG. 1 is a flow chart illustrating a method for implementing GPS surveying field work planning using 3D topographic information according to the embodiment of the present invention;

FIG. 2 is a flow chart illustrating a conventional method for analyzing 3D topographic information;

FIG. 3 is a flow chart illustrating a method for analyzing 3D topographic information according to the present invention;

FIG. 4 is a diagram showing relation between slope and resolution of digital terrain model;

FIG. 5A is a diagram showing geometrical relation among view angle resolution, height, and distance;

FIG. 5B is a diagram showing geometrical relation among grid size, view angle resolution and distance in the terrain;

FIG. 5C is a diagram showing geometrical relation among grid size, view angle resolution and the distance in a plane; and

FIG. 6 is a table showing the efficiency comparison of various sampling methods.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

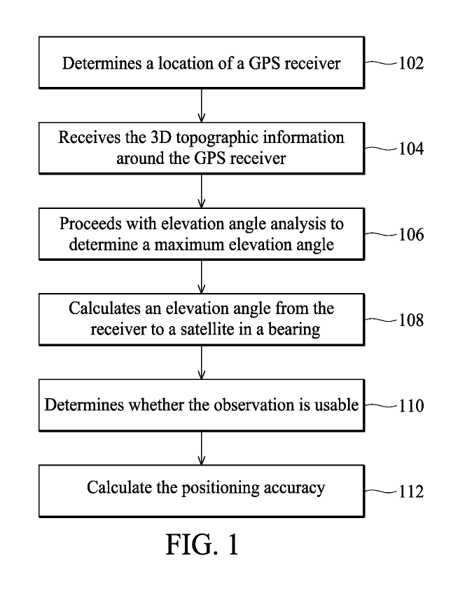

FIG. 1 is a flow chart illustrating a method for implementing GPS surveying field work planning using 3D topographic information according to the embodiment of the present invention. In step 102, a user determines a location of a GPS receiver. The user selects a location for settling the GPS receiver on a three dimensional topographic map, and sets relevant parameters such as measuring timing, etc. Next, in step 104, the user receives the 3D topographic information around the GPS receiver. In the embodiment, the Digital Surface Model (DSM) is used as the 3D topographic information.

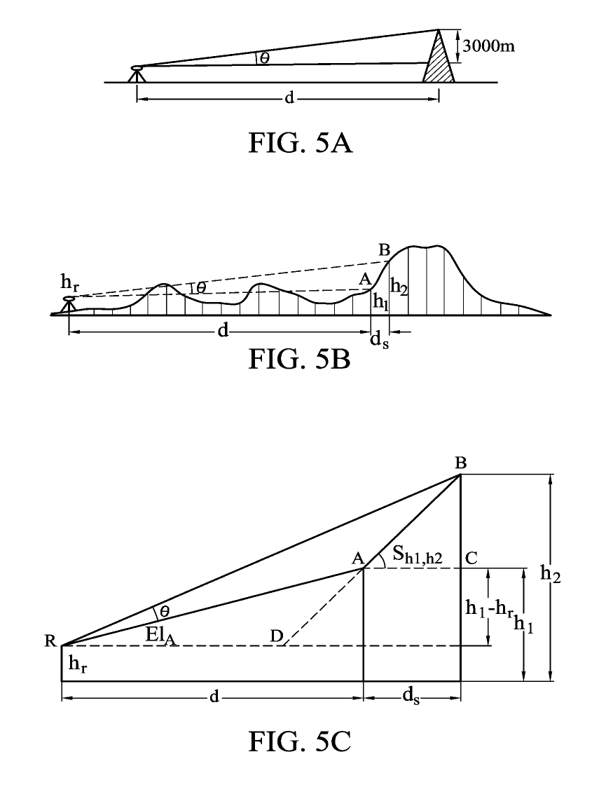

In step 106, the user proceeds with elevation angle analysis (i.e. terrain obstruction analysis) to determine a maximum elevation angle. In this step, a self-adaptive visibility analysis is used instead of the conventional visibility analysis, wherein a target point is set and a horizontal area is determined to limit the analysis range. The target point is the receiver location and the horizontal area is a reasonable regional range, determined by taking the receiver as a center point and referring terrain heights and view angle resolution of satellites (see FIG. 5A). Next, the digital terrain information is sampled with different intervals to obtain heights of the sampling points. Note that non-equivalent interval sampling is used, wherein the points on the topographic are sampled with concentrated grid sizes near the receiver, while others are sampled with wider grid sizes far from the receiver. The angles from the heights of the sampling points to the location are elevation angles. After comparing these elevation angles along an azimuth of the receiver, the maximum elevation angle in this azimuth is determined.

Next, in step 108, an elevation angle from the receiver to a satellite in a bearing is calculated. The satellite orbit coordinates are firstly determined by the satellite ephemeris and almanac, and then the elevation angel of the bearing from the receiver to the satellite is calculated according to the coordinates and the receiver location. Next, in step 110, it is determined whether the observation is visible. The satellite observation is usable when the satellite is not obstructed by the terrain along the azimuth such that the elevation angle from the receiver to the satellite is larger than the maximum topographic elevation along this bearing. For example, if the location of a satellite relative to the receiver is at a position with an azimuth of 270 degrees and the elevation angle is 45 degrees, and the maximum topographic elevation angle along the bearing is 30 degrees. It is understood that the signals from the satellite will not be blocked by the terrain along this bearing because the maximum topographic elevation angle is smaller than the elevation angel from the receiver to the satellite, so the satellite is visible. Finally, in step 112, the positioning accuracy is calculated. The number of the usable satellite observations at the location of the receiver is obtained via the above mentioned steps, and the positioning accuracy is determined according to this visible satellite observations.

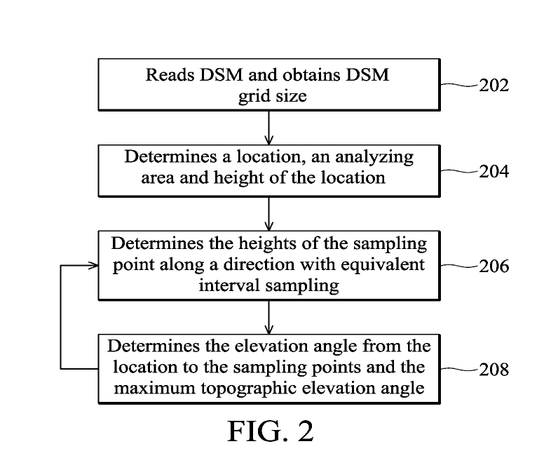

FIG. 2 is a flow chart illustrating a conventional method for analyzing 3D topographic information. In step 202, the Digital Surface Model (DSM) is loaded into a computer system and the grid size (or resolution) of the DSM is obtained. The grid size determines the geographic map resolution. In step 204, a location, an analyzing area and the height of the location are determined. The height of the location is obtained by the interpolation of nearby DSM points. Afterwards, in step 206, an equivalent interval sampling is used to determine the heights of the sampling points along a azimuth. The grid sizes for each azimuth are the same as the grid size of the DSM data in this conventional case. An interpolation method, such as bilinear interpolation, is used to determine the heights of the sampling points. Finally, in step 208, the elevation angle from the location to the sampling points and the maximum topographic elevation angle are determined. The angle from the height on the sampling point to the height of the location is the elevation angle. The maximum topographic elevation angle along a azimuth is the maximum value among these elevation angles. Following, the step return to step 206 until the analysis of 360 degree azimuths are completed.

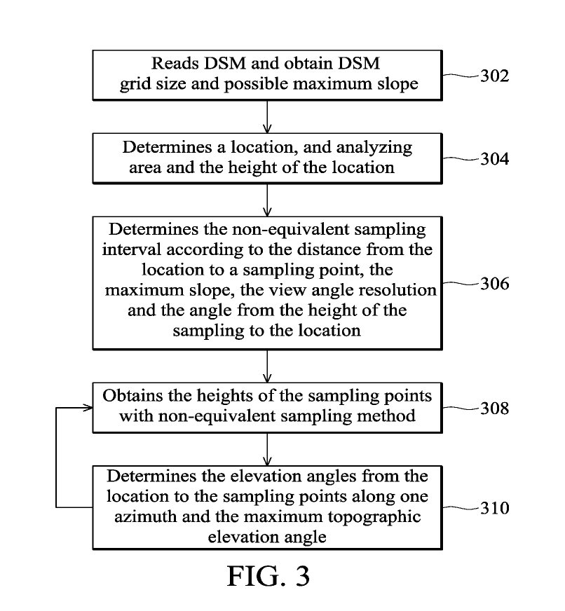

FIG. 3 is a flow chart illustrating a method for analyzing 3D topographic information according to the present invention. In step 302, a DSM is read out, and the grid size of the DSM and the possible maximum slope is obtained. In the embodiment, a DSM with 10 meter resolution is led in. The maximum possible slope is obtained in accordance with the DSM data.

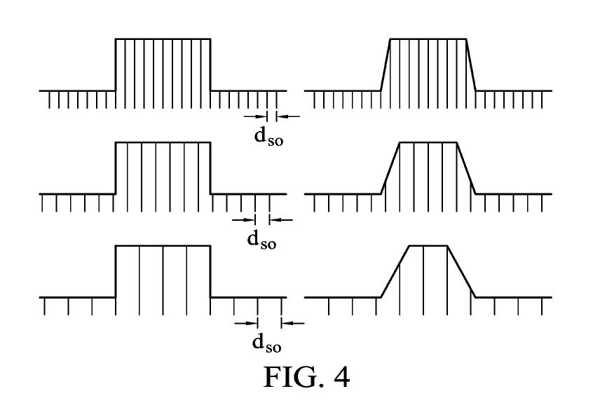

It is well known by those skilled in the art, that the data from the current digital terrain model is built with different grid sizes or resolutions. The greater the number of the grid size, the more precise of the terrain. The smaller the grid size, the clearer the steep slope shown in FIG. 4. This slope is calculated according to the height offset and the grid size. That is, the maximum slope Sₘₐₓ can be estimated according to the grid size and the maximum relief offsets data of the DSM data. The formula is as follows:

$${S}_{max} = arctan ( \frac{Δ {h}_{max}}{{d}_{s 0}} ) \qquad ( 1 )$$

, where Δhₘₐₓ is the possible maximum relief offset, which can be calculated according to the DSM data or set by the user, and dₛ₀ is the grid size of the DSM. The two values are the parameters used for calculating non-equivalent grid sizes in subsequent steps. In another embodiment, the slope can be set at a constant 85 degrees.

Next, in step 304, a location, an analyzing area, and the height of the location are determined. A location is selected on the DSM map to simulate the settling location of the receiver, and the height of the location is obtained by interpolation. A relief offset larger than 3000 meters in a local area of the earth is rarely seen. For this reason, the height of 3000 meters is set as a maximum possible relief offset for analysis. The view angle resolution θ is set at 1 degree. The DSM range can be derived from the geometrical figure, as shown in the FIG. 5A, d is about 171870 meters. The DSM map (or data range) beyond 171870 meters will not apparently affect the visibility analysis.

Next, in step 306, the non-equivalent grid size is determined according to the distance from the location to a sampling point, the maximum slope, the view angle resolution and the elevation angle from the sampling point to the location. The sampling point is selected by the self-adaptive non-equivalent grid size. The algorithm applies a geometrical principle to transfer a real terrain as shown in FIG. 5B to a plane triangle geometrical pattern as shown in FIG. 5C, before the formula of the grid size is derived. In the FIG. 5C, R is the settled location of the receiver, A and B are two sampling points, h₁ and h₂ are respectively the heights of the points A and B. The formula is as follows:

$${d}_{s} = \frac{d \times sin ∠ θ \times cos {S}_{h 1 , h 2}}{sin ( {S}_{h 1 , h 2} - ∠ {El}_{A} - ∠ θ ) \times cos {El}_{A}} \qquad ( 2 )$$

, where d is a distance from the receiver to the point A to be sampled, dₛ is a interval from the present sampling point A to the next sampling point B, θ is the elevation angle offset (equal to the view angle resolution) between sampling point A and B, S_{h1,h2} is a slope angle from A to B, El_{A} is an elevation angle from the sampling point A to the location R. It is understood by the formula (2) that 1) when θ-El_{A}-S_{h1,h2} are fixed, dₛ is linear to d. That is, the grid size dₛ can be larger as the sampling point is farther away from the location R; 2) When the gradient S_{h1,h2} becomes larger, then the grid size dₛ will become smaller. 3) When θ-d-S_{h1,h2} are fixed, dₛ is dependent on El_{A}, and the smaller El_{A} is, the smaller dₛ is.

To summary, (1) the same view angle resolution θ can be determined with sparse sampling points when the sampling points are far away from the location. (2) The smaller the elevation angle are, the more concentrated the sampling points are. (3) The steeper the slope between the two sampling points is, the more concentrated the sampling points are.

In the embodiment, the view angle resolution θ is set at 1 degree, El_{A} from sampling point to the location is set as zero, S_{h1,h2} is the maximum slope angle Sₘₐₓ calculated from the DSM data. According to the above, grid size dₛ is linear to distance d.

In another embodiment, the view angle resolution θ is set at 1 degree, El_{A} from sampling point to the location is set as zero, S_{h1,h2} is assumed as 85 degree (slope angle is from the real DSM data, with limited resolution so that the angle can not be vertical, and 85 degrees is close to the extreme for example), According to the above, the grid size dₛ is linear to distance d, so that the number of the sampling points are less than that in the conventional method.

In another embodiment, the view angle resolution θ is set at 1 degree, the angle El_{A} is from a sampling point to the location, the slope S_{h1,h2} is calculated according to the real value in the DSM data. Referring to the formula (2), El_{A}, S_{h1,h2} and d are variable so that the grid size d, will be a non-equivalent interval.

Next, in step 308, the heights of the sampling points are obtained with non-equivalent grid sizes. According to the formula (2), the location of the receiver is a starting point. The heights of the terrain are sampled one time per one interval dₛ with the interpolation method, such as a bilinear method or nearest-neighbor method. In the embodiment, if the sampling resolution dₛ is smaller than the DSM resolution (10 meters in the embodiment), then it is detemined as being over-sampled, and the dₛ value is replaced with the DSM resolution, 10 meters.

Finally, in step 310, the elevation angles from the location to the sampling points along one azimuth are calculated and the maximum topographic elevation angle is determined. The angle from a sampling point to the location is the elevation angle. The maximum topographic elevation angle can be determined by comparing the elevation angles among one another. Next, in step 308 is performed, wherein the visibility analysis of another azimuth is proceeded until the range of 360 degrees azimuth is completed.

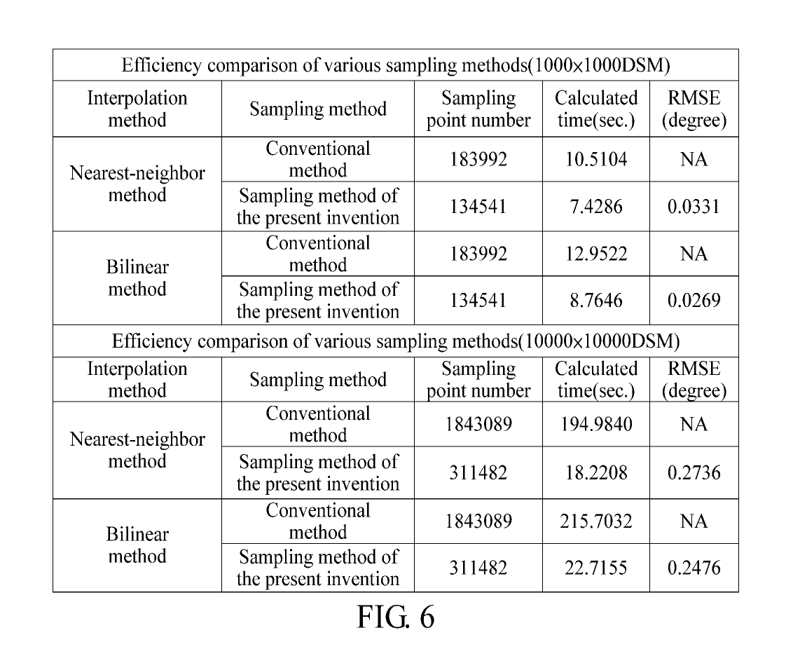

FIG. 6 is a table showing efficiency comparison of various sampling methods. The root-mean-square-error (RMSE) values are calculated by comparison between the conventional method (treated as true values) and the method in present invention. The outcomes in the top table are from an 1000*1000 resolution DSM, and the outcomes of the down table are from an 10000*10000 resolution DSM. It is noted that the new outcomes from the two linear or nearest neighbor method are improved when compared to the outcomes from the conventional method. The RMSE is very insignificant that the satellite visibility analysis will not be apparently affected by the outcomes. The RMSE in the down table of FIG. 6 is higher than that in the top table, but the computation speed is apparently faster.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for implementing GPS surveying field work planning by using three dimensional topographic information, comprising:
obtaining three dimensional topographic information according to the location of a GPS receiver;
obtaining maximum topographic elevation angle information from the GPS receiver to terrain for each azimuth using the three dimensional topographic information;
obtaining elevation angle information from the GPS receiver to satellites along the satellite bearings according to the satellite ephemeris or almanac;
determining whether observation is visible according to the maximum topographic elevation angle information along the satellite bearings, and the elevation angle information from the GPS receiver to the satellites; and
estimating the positioning accuracy using the usable satellite observations.

2. The method as claimed in claim 1, wherein the determining whether observation information is usable comprises:
comparing a maximum topographic elevation angle and an elevation angle of a satellite, and when the elevation angle is larger than the maximum topographic elevation angle, the observation is determined to be usable.

3. The method as claimed in claim 1, wherein obtaining the maximum topographic elevation angle information comprises:
analyzing the three dimensional information to obtain topographic heights; and
obtaining the maximum topographic elevation angles according to the topographic heights.

4. The method as claimed in claim 3, wherein analyzing the three dimensional information comprises:
sampling the three dimensional topographic information with different grid sizes to obtain the topographic heights of the sampling points.

5. The method as claimed in claim 4, wherein analyzing the three dimensional information further comprises:
determining a area to limit a sampling range according to the location of the GPS receiver.

6. The method as claimed in claim 5, wherein obtaining the maximum topographic elevation angles comprises:
obtaining the topographic elevation angles according to the height of the location and the heights of the sampling points; and
obtaining the maximum values according to these topographic elevation angles.

7. A method for analyzing 3D topographic information, comprising:
obtaining topographic information;
determining a location and a analysis area;
obtaining topographic heights in the area with different grid sizes according to the topographic information, wherein the grid sizes are proportional to the distance between the location and the sampling points; and
obtaining maximum topographic elevation angle information according to the topographic heights and the height of the location.

8. The method as claimed in claim 7, wherein the grid sizes are sharply reduced when the slope between the topographic heights on two sampling points is increased.

9. The method as claimed in claim 7, wherein the grid sizes are sharply enlarged when the angle between the location and the topographic height on a sampling point is increased.
